(19) United States
(12) Patent Application Publication
(10) Pub. No.: US 2026/0178248 A1
(43) Pub. Date: Jun. 25, 2026

(54) TERMINAL DEVICE, INFORMATION PROCESSING SYSTEM, AND NON-TRANSITORY COMPUTER-READABLE STORAGE MEDIUM STORING PROGRAM

(71) Applicant: SEIKO EPSON CORPORATION, TOKYO (JP)

(72) Inventor: Shusuke KIBUNE, MATSUMOTO-SHI (JP)

(21) Appl. No.: 19/432,169

(22) Filed: Dec. 24, 2025

(30) Foreign Application Priority Data
Dec. 25, 2024 (JP) 2024-228418

(51) Int. Cl. G06F 3/12

(52) U.S. Cl. CPC G06F 3/1236; G06F 3/122; G06F 3/1239; G06F 3/1253; G06F 3/1288

(57) ABSTRACT

A terminal device includes a state determination unit configured to determine whether a communication state between a printing device and the terminal device is a first state or a second state, and a UI control unit configured to control a user interface. The UI control unit restricts reception of an instruction for transmitting print data to the printing device from a user when the communication state is the first state, and receives the instruction for transmitting the print data to the printing device from the user when the communication state is the second state.

The present application is based on, and claims priority from JP Application Serial Number 2024-228418, filed December 25, 2024, the disclosure of which is hereby incorporated by reference herein in its entirety.

### BACKGROUND

### 1. Technical Field

The present disclosure relates to a terminal device, an information processing system, and a non-transitory computer-readable storage medium storing a program.

### 2. Related Art

A printing device may be operated by being connected to a network. Specifically, for example, as disclosed in JP-A-2024-103002, a technique of transferring print data from a terminal device to a printing device via a local area network (LAN) or uploading information of the printing device to a server on the Internet is known.

JP-A-2024-103002 is an example of the related art.

When the printing device receives and prints the print data transferred from the terminal device, it is preferable that the print data is transferred using a communication path capable of achieving an appropriate data transfer speed. This is because when the data transfer speed is low, the transfer of the print data is not in time for a printing speed of the printing device, and printing cannot be appropriately executed. Therefore, it is required to reduce occurrence of a situation in which the transfer of the print data to the printing device is not in time for the printing speed of the printing device due to the transfer of the print data using an inappropriate communication path.

### SUMMARY

A terminal device according to the present disclosure is a terminal device that communicates with a printing device. The terminal device includes: a state determination unit configured to determine whether a communication state between the printing device and the terminal device is a first state in which communication is possible via a first communication path and is not possible via a second communication path or a second state in which communication is possible via the second communication path; and a user interface control unit configured to control a user interface. The first communication path and the second communication path are communication paths in which communication is performed according to different standards, and the user interface control unit restricts reception of an instruction for transmitting print data to the printing device from a user when the communication state is the first state, and receives the instruction for transmitting the print data to the printing device from the user when the communication state is the second state.

An information processing system according to the present disclosure includes: a printing device configured to transmit operation information to a cloud server using a first communication path; and a terminal device configured to communicate with the printing device. The terminal device includes a state determination unit configured to determine whether a communication state between the printing device and the terminal device is a first state in which communication is possible via the first communication path and is not possible via a second communication path or a second state in which communication is possible via the second communication path, and a user interface control unit configured to control a user interface, in which the first communication path and the second communication path are communication paths in which communication is performed according to different standards, and the user interface control unit restricts reception of an instruction for transmitting print data to the printing device from a user when the communication state is the first state, and receives the instruction for transmitting the print data to the printing device from the user when the communication state is the second state.

A non-transitory computer-readable storage medium storing a program according to the present disclosure causes a computer of a terminal device that communicates with a printing device to execute operations including: a state determination step of determining whether a communication state between the printing device and the terminal device is a first state in which communication is possible via a first communication path and is not possible via a second communication path or a second state in which communication is possible via the second communication path; and a user interface control step of controlling a user interface, in which the first communication path and the second communication path are communication paths in which communication is performed according to different standards, and in the user interface control step, reception of an instruction for transmitting print data to the printing device from a user is restricted when the communication state is the first state, and the instruction for transmitting the print data to the printing device is received from the user when the communication state is the second state.

### BRIEF DESCRIPTION OF THE DRAWINGS

FIG. 1 is a block diagram illustrating an example of a configuration of an information processing system according to an embodiment.

FIG. 2 is a block diagram illustrating an example of a configuration of a terminal device according to Embodiment 1.

FIG. 3 is a schematic diagram illustrating an example of a GUI screen displayed on an output device by a UI control unit.

FIG. 4A is a schematic diagram illustrating an example of the GUI screen displayed on the output device by the UI control unit.

FIG. 4B is a schematic diagram illustrating an example of the GUI screen displayed on the output device by the UI control unit.

FIG. 5 is a flowchart illustrating an example of a flow of processing related to execution of restriction processing according to Embodiment 1.

FIG. 6 is a schematic diagram illustrating an example of the GUI screen displayed on the output device by the UI control unit.

FIG. 7 is a schematic diagram illustrating an example of the GUI screen displayed on the output device by the UI control unit.

FIG. 8 is a block diagram illustrating an example of a configuration of a terminal device according to Embodiment 2.

FIG. 9 is a flowchart illustrating an example of a flow of processing related to execution of restriction processing according to Embodiment 2.

### DESCRIPTION OF EMBODIMENTS

Embodiments and the like are described below with reference to the drawings. To clarify the description, the following description and the drawings are omitted and simplified as appropriate. In the drawings, the same elements are denoted by the same reference numerals and signs and redundant description of the elements is omitted according to necessity.

In recent years, commercial or industrial printing devices have become mainstream in uploading information from a LAN port of a printing device to a cloud server via the Internet so that a user can remotely monitor information and the like of the printing device. In this case, since the printing device is connected to the LAN, the printing device can receive print data transferred via the LAN. Meanwhile, high-speed printing is possible in the commercial or industrial printing devices. For example, a printing device for direct to fabric (DTF) can perform high-speed printing by incorporating a plurality of ink heads. When print data is transferred from a terminal device to such a printing device that performs printing at high speed, in LAN communication, that is, communication using a communication path conforming to an Ethernet standard, transfer of the print data may not be in time for printing processing in the printing device. In particular, when a 1 gigabit (Gb) Ethernet cable, which is currently widely used, is used, since a theoretical maximum data transfer speed is 125 megabytes/sec (MB/sec), transfer of print data may not be in time for printing processing in a printing device. When the transfer of the print data is not in time for the printing processing, an operation of an ink head of the printing device stops. Accordingly, the printing processing is delayed. Deterioration in print image quality and damage to print media (paper, cloth, and the like) may occur. In order to solve such a problem, in a printer that requires high-speed data transfer, it is preferable to limit the transfer of print data to a communication path that can achieve high-speed data transfer, such as Universal Serial Bus (USB) 3.0. Therefore, in the present disclosure, a technique for achieving transfer of print data using an appropriate communication path will be described.

### Embodiment 1

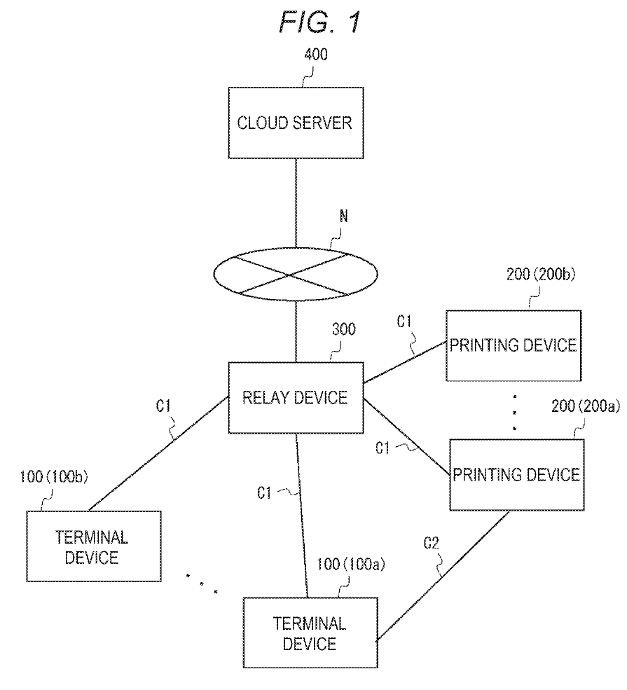

FIG. 1 is a block diagram illustrating an example of a configuration of an information processing system 1 according to the embodiment. In the example illustrated in FIG. 1, the information processing system 1 includes one or more printing devices 200, a cloud server 400, and one or more terminal devices 100. The information processing system 1 may include a relay device 300 as illustrated in FIG. 1.

The printing device 200 and the terminal device 100 are devices connected to a LAN. In the example illustrated in FIG. 1, the printing device 200 and the terminal device 100 are connected to the LAN constructed using the relay device 300. The relay device 300 is, for example, a network relay device such as a network hub (switching hub), and may have a function as a router. The relay device 300 is connected to each device constituting the LAN by a LAN cable (Ethernet cable). Specifically, the relay device 300 and the terminal device 100 or the printing device 200 are communicably connected by a cable C1 conforming to the Ethernet standard. Therefore, each terminal device 100 is communicably connected to the printing device 200 via the LAN (via Ethernet).

The relay device 300 is also connected to a network N that is a wide area network (WAN) such as the Internet. The cloud server 400 is connected to the network N. Therefore, the terminal device 100 and the printing device 200 can communicate with the cloud server 400 on the network N via the cable C1.

The printing device 200 is a device that receives print data transferred from the terminal device 100 and executes printing processing based on the received print data. For example, the printing device 200 may be a textile printer that prints an image on a fabric according to print data. The printing device 200 is, for example, a printer that requests a predetermined speed (for example, a predetermined speed faster than a theoretical maximum speed of 1 Gb Ethernet communication) or higher as a data transfer speed for normal printing processing (a data transfer speed for not causing a delay in printing processing). The printing device 200 is, for example, a commercial or industrial printing device, but is not necessarily a commercial or industrial printing device.

The printing device 200 can communicate with the terminal device 100 via a communication path other than the LAN. Specifically, the printing device 200 and the terminal device 100 can communicate with each other via a communication path conforming to a USB standard. That is, at least some of the printing devices 200 in the information processing system 1 include not only a network interface for communication conforming to the Ethernet standard but also a network interface for communication conforming to the USB standard. In the embodiment, the network interface for communication conforming to the USB standard that can be provided in the printing device 200 is a network interface conforming to the USB 3.0 standard or successor standards thereof (for example, USB 3.1, USB 3.2) to enable high-speed reception of print data. Therefore, the printing device 200 and the terminal device 100 can communicate with each other via a communication path conforming to the USB 3.0 standard or the successor standard thereof. In the following description, the USB 3.0 standard or the successor standard thereof is simply referred to as the USB standard. In FIG. 1, of the terminal devices 100 in the information processing system 1, the terminal device 100 connected to the printing device 200 via a cable C2 conforming to the USB standard is referred to as a terminal device 100a, and the terminal device 100 not connected to the printing device 200 via the cable C2 conforming to the USB standard is referred to as a terminal device 100b. Similarly, in FIG. 1, of the printing devices 200 in the information processing system 1, the printing device 200 connected to the terminal device 100 via the cable C2 conforming to the USB standard is referred to as a printing device 200a, and the printing device 200 not connected to the terminal device 100 via the cable C2 conforming to the USB standard is referred to as a printing device 200b.

Thus, the printing device 200 can be connected to two communication paths in which communication is performed according to different standards to communicate with another device. Of these, a communication path in which communication is performed according to the Ethernet standard is a specific example of a first communication path in the present disclosure. A communication path in which communication is performed according to the USB standard (USB 3.0 standard or the successor standard thereof) is a specific example of a second communication path in the present disclosure. In the embodiment, the printing device 200 is connected to the first communication path (communication path conforming to the Ethernet standard) to transmit operation information of the printing device 200 to the cloud server 400. In the embodiment, the printing device 200 can be connected to the second communication path (communication path conforming to the USB standard) to receive print data transferred at high speed. The printing device 200 can also receive the print data transferred via the first communication path, but in the embodiment, a data transfer speed of the first communication path is slower than a data transfer speed of the second communication path. This is because, in a case of 1 Gb Ethernet communication which is generally widely used, a theoretical maximum speed of the data transfer speed is 125 MB/sec, whereas a theoretical maximum speed of the communication according to the USB 3.0 standard is 625 MB/sec. In communication using the first communication path (communication path conforming to the Ethernet standard), for example, due to communication congestion, the data transfer speed may be significantly lower than the theoretical maximum speed. Thus, in the embodiment, the data transfer speed of the second communication path is faster than the data transfer speed of the first communication path. The data transfer speed of the second communication path is preferably, for example, 150 MB/sec or more.

The cloud server 400 receives the operation information of the printing device 200 from the printing device 200. When the information processing system 1 includes a plurality of printing devices 200, the cloud server 400 receives operation information from each of the printing devices 200. As described above, the printing device 200 uploads the operation information to the cloud server 400 using the communication path conforming to the Ethernet standard. For example, the printing device 200 periodically transmits the operation information to the cloud server 400. The operation information is information indicating an operation status of the printing device 200, and is, for example, information indicating a printing result of the printing device 200, a use amount of consumables (ink, print medium, and the like), and an operation time. The cloud server 400 provides the received operation information to any device that can access the cloud server 400, such as the terminal device 100. For example, a device that accesses the cloud server 400 displays the operation information on a display of the device using a browser.

Next, the terminal device 100 that communicates with the printing device 200 will be described in detail. The terminal device 100 is a device having a function as a computer, and is, for example, a device such as a personal computer, a smartphone, or a tablet.

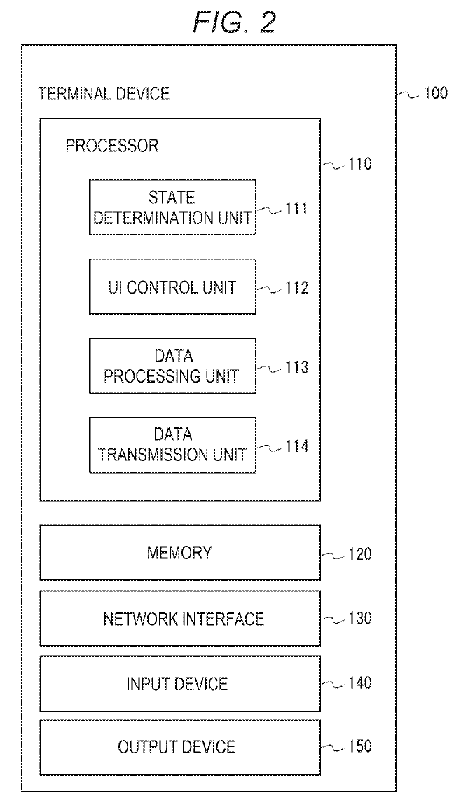

FIG. 2 is a block diagram illustrating an example of a configuration of the terminal device 100 according to Embodiment 1. As illustrated in FIG. 2, the terminal device 100 includes a processor 110, a memory 120, a network interface 130, an input device 140, and an output device 150.

The network interface 130 is an interface for communicating with other devices. The terminal device 100 may include a plurality of network interfaces 130. In the embodiment, the terminal device 100 includes, for example, the network interface 130 for communication conforming to the Ethernet standard and the network interface 130 for communication conforming to the USB standard. That is, the terminal device 100 includes an interface connectable to the cable C1 and an interface connectable to the cable C2.

The memory 120 is implemented with, for example, a combination of a volatile memory and a nonvolatile memory. The memory 120 is used to store a program executed by the processor 110 and data and the like used in various types of processing.

The processor 110 may be, for example, a microprocessor, a micro processor unit (MPU), or a central processing unit (CPU). The processor 110 may include a plurality of processors.

The processor 110 reads a program from the memory 120 and executes the program. Accordingly, the processor 110 achieves functions of a state determination unit 111, a UI control unit 112, a data processing unit 113, and a data transmission unit 114, which will be described later. In the embodiment, the state determination unit 111, the UI control unit 112, the data processing unit 113, and the data transmission unit 114 are implemented as programs for a printing application. More specifically, in the embodiment, the printing application is, for example, a raster image processor (RIP) application.

The input device 140 is a device that receives an input operation from a user of the terminal device 100, and is a keyboard, a pointing device, or the like. The output device 150 is a device that displays information, and is, for example, a flat panel display such as a liquid crystal display, a plasma display, or an organic electro-luminescence (EL) display. The terminal device 100 may include a touch panel in which the input device 140 and the output device 150 are integrally implemented.

Hereinafter, the state determination unit 111, the UI control unit 112, the data processing unit 113, and the data transmission unit 114 will be described. As described above, in the embodiment, these are functions that the RIP application has.

The state determination unit 111 searches for the printing device 200 communicably connected to the terminal device 100, and specifies a communication path communicable with the printing device 200. Specifically, for example, the state determination unit 111 outputs a predetermined request signal from each network interface 130 in the terminal device 100 to the printing device 200 requesting a response. The printing device 200 that receives the request signal returns a response signal to the terminal device 100. This response signal can include any information about the printing device 200. For example, the response signal may include identification information such as a model name of the printing device 200. When a request signal and a response signal are transmitted and received via a communication path conforming to the Ethernet standard, the response signal may include an Internet Protocol (IP) address of the printing device 200. When receiving a request signal from each of different communication paths, the printing device 200 transmits a response signal using each of the communication paths. The state determination unit 111 checks through which network interface 130 the response signal is received, thereby finding out the printing device 200 communicably connected to the terminal device 100 and specifying a communication path communicable with the printing device 200. In the embodiment, since the USB standard supported by the printing device 200 is a standard of USB 3.0 or higher, reception of the response signal from the printing device 200 in the network interface 130 for USB of the terminal device 100 means that communication according to the standard of USB 3.0 or higher is possible. Although an example of specific processing of searching for the printing device 200 and specifying the communication path is described above, the state determination unit 111 may search for the printing device 200 and specify the communication path by another method.

The state determination unit 111 specifies an available communication path for each of the printing devices 200 communicably connected to the terminal device 100. The state determination unit 111 determines whether a communication state between the printing device 200 and the terminal device 100 is a first state or a second state for each of the printing devices 200 communicably connected to the terminal device 100. Here, the first state refers to a state in which communication is possible via the first communication path and is not possible via the second communication path. That is, specifically, the first state refers to a state in which the terminal device 100 can communicate with the printing device 200 to be determined via a communication path conforming to the Ethernet standard, but cannot communicate with the printing device 200 via a communication path conforming to the USB standard. When the communication state between the printing device 200 and the terminal device 100 is the first state, it means that the print data can be transferred from the terminal device 100 to the printing device 200 but cannot be transferred at high speed. Hereinafter, the first state is referred to as a low-speed connection state. The second state refers to a state in which communication is possible via the second communication path. That is, specifically, the second state refers to a state in which the terminal device 100 can communicate with the printing device 200 to be determined via a communication path conforming to the USB standard. When the communication state between the printing device 200 and the terminal device 100 is the second state, it means that the print data can be transferred at high speed from the terminal device 100 to the printing device 200. Hereinafter, the second state is referred to as a high-speed connection state.

The user interface (UI) control unit 112 controls a user interface. For example, the UI control unit 112 executes processing of displaying a graphical user interface (GUI) screen on the output device 150 according to an operation input from the user via the input device 140. Details of the processing of the UI control unit 112 will be described later.

The data processing unit 113 generates print data corresponding to the printing device 200 based on image data read by the printing application (RIP application). For example, the data processing unit 113 generates print data by executing processing such as resolution conversion processing, color conversion processing, halftone processing, rasterization processing, and command addition processing on the image data. The print data is data for controlling printing by the printing device 200. More specifically, the data is data in a format that can be interpreted by the printing device 200 and includes various types of command data and pixel data. Here, the command data is data for instructing the printing device 200 to execute a specific operation. The pixel data is data related to pixels constituting an image to be printed (print image), and is, for example, data indicating a color and size of dots formed on a medium. The terminal device 100 stores, in advance, for each printing device (model) of various printing devices (models) that may be registered in the printing application (RIP application), setting information for generating print data corresponding to that printing device, for example, in the memory 120. The data processing unit 113 generates print data corresponding to the printing device 200 by switching the setting information to be referred to depending on which printing device 200 the print data is generated for.

In the embodiment, when the UI control unit 112 receives an instruction to execute processing of generating print data, the data processing unit 113 generates the print data.

The data transmission unit 114 transmits the print data generated by the data processing unit 113 to the printing device 200 corresponding to the print data. The data transmission unit 114 transmits the print data to the printing device 200 as a transmission destination via a designated communication path. As will be described later, in the embodiment, the printing device 200 as the transmission destination needs to be registered in the printing application, and a communication path to be used for transfer of the print data is designated for the registered printing device 200 at the time of registration. In the embodiment, when the UI control unit 112 receives an instruction to execute processing of transferring the print data to the printing device 200, the data transmission unit 114 transmits the print data to the printing device 200. As will be described later, even when an instruction is input from the user, the UI control unit 112 may not receive the instruction.

Next, the UI control unit 112 will be described in detail. As described above, the UI control unit 112 controls the user interface. More specifically, the UI control unit 112 controls a graphical user interface (GUI) for the printing application (RIP application). In the embodiment, among the printing devices 200 capable of communicating with the terminal device 100, the printing device 200 registered in the printing application is to be handled on the printing application. Therefore, the user first performs an operation of registering a desired printing device 200 among the printing devices 200 capable of communicating with the terminal device 100 by using a GUI screen provided by the UI control unit 112. In the embodiment, the registration is performed with designation of a communication path used for the transfer of the print data. In the embodiment, even when there are two communication paths as communication paths for communicating with the printing device 200 to be registered, only one communication path can be designated at the time of registration.

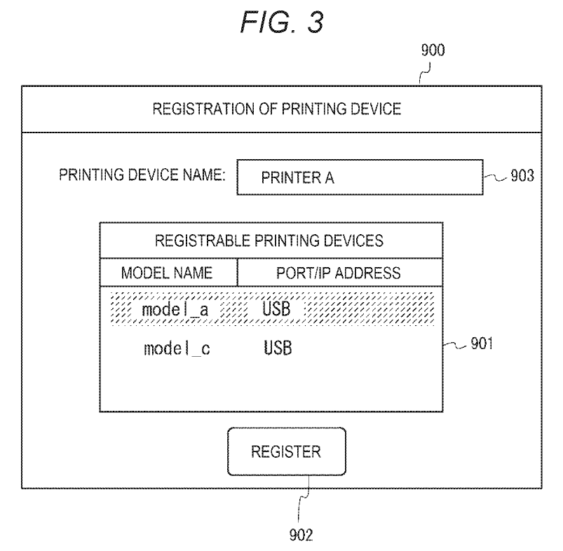

FIG. 3 is a schematic diagram illustrating an example of a GUI screen 900 for registering a printing device displayed on the output device 150 by the UI control unit 112. The UI control unit 112 displays the GUI screen 900 listing the registrable printing devices 200 on the output device 150. The user selects one of the printing devices 200 listed in a list 901 and then presses a register button 902. Accordingly, the UI control unit 112 registers the selected printing device 200 as a printing device to be handled on the printing application. The user may designate a name for identifying the printing device 200 to be registered by inputting the name to an input field 903 using the input device 140. In this case, the UI control unit 112 registers the input name as the name of the printing device 200 to be registered.

The UI control unit 112 may display, on the output device 150, the GUI screen 900 for listing only the printing devices 200 whose communication state with the terminal device 100 is the high-speed connection state as the registrable printing devices 200. More specifically, the UI control unit 112 may display, on the output device 150, the GUI screen 900 for listing only a connection form by the second communication path of the printing device 200 whose communication state with the terminal device 100 is the high-speed connection state, as the registrable printing device and the connection form. That is, the UI control unit 112 may display, on the output device 150, the GUI screen 900 that enables registration of the printing device 200 accompanied by designation of the second communication path as the communication path used for the transfer of the print data and prevents registration of the printing device 200 accompanied by designation of the first communication path as the communication path used for the transfer of the print data. Thus, the UI control unit 112 may display, on a user interface screen, the printing device 200 whose communication state with the terminal device 100 is the high-speed connection state in a selectable manner, and may not display, on the user interface screen, the printing device 200 whose communication state with the terminal device 100 is the low-speed connection state in a selectable manner. In other words, the UI control unit 112 may display, on the user interface screen, the printing device 200 whose communication state with the terminal device 100 is the high-speed connection state as a selectable device, and may not display, on the user interface screen, the printing device 200 whose communication state with the terminal device 100 is the low-speed connection state as the selectable device. More specifically, the selectable device refers to a device that can be selected by the user using the input device 140 as a processing target (for example, a registration processing target) device.

For example, on a GUI screen for registration, the UI control unit 112 of the terminal device 100a in FIG. 1 lists the printing device 200a (more specifically, the printing device 200a designating USB communication as a communication path to be used for the transfer of the print data) as a registrable printing device, but does not list the printing device 200b. For example, the UI control unit 112 of the terminal device 100b in FIG. 1 does not list any of the printing devices 200 as a registrable printing device because the terminal device 100b cannot perform USB communication with any of the printing devices 200. By executing such processing, it is possible to prevent the printing device 200 whose communication state with the terminal device 100 is the low-speed connection state from being registered in the printing application. When such a printing device 200 is not registered, the user does not input a print instruction for the printing device 200. Therefore, it is possible to prevent the print data from being transferred to the printing device 200 via the first communication path (Ethernet communication path). Processing of not displaying the printing device 200 whose communication state with the terminal device 100 is the low-speed connection state as a selectable device on the user interface screen for registration is an example of restriction processing executed by the UI control unit 112. Here, the restriction processing refers to processing of restricting reception of a print instruction from the user for the printing device 200 whose communication state with the terminal device 100 is the low-speed connection state. The print instruction is an instruction to transmit print data to the printing device 200.

When the UI control unit 112 executes other restriction processing to be described later, the printing device 200 whose communication state with the terminal device 100 is the low-speed connection state may be registered. That is, in this case, the UI control unit 112 may also list the printing device 200 whose communication state with the terminal device 100 is the low-speed connection state as a registrable printing device on the user interface screen for registration.

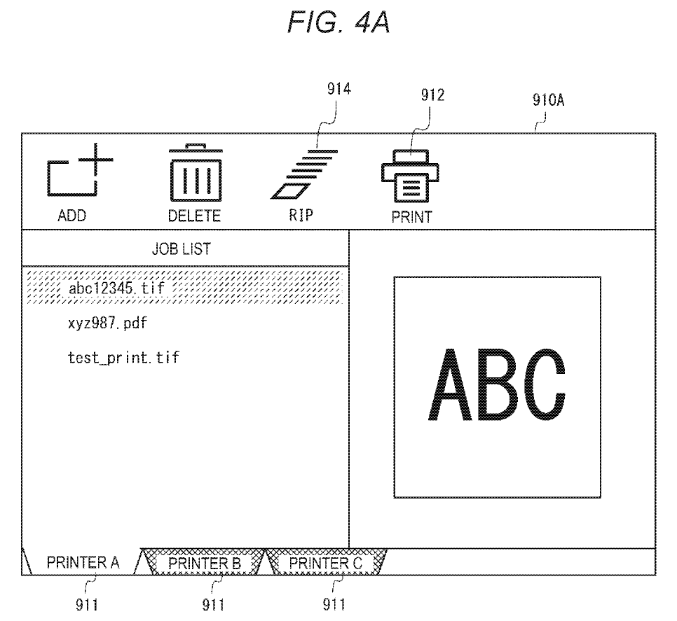

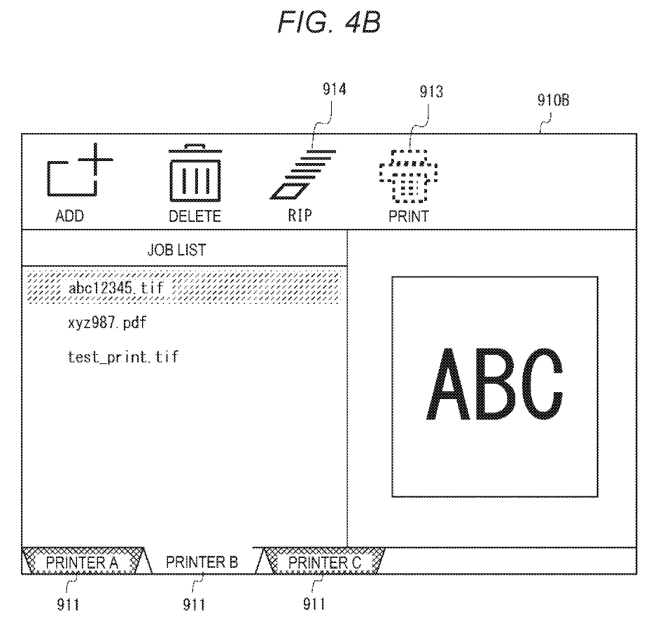

Next, the other restriction processing of the UI control unit 112 will be described. FIGS. 4A and 4B are schematic diagrams illustrating examples of GUI screens displayed on the output device 150 by the UI control unit 112. FIGS. 4A and 4B illustrate the GUI screens for generating print data that can be input to the registered printing device 200. By selecting a tab 911 provided on the GUI screen, the user can select, from among the registered printing devices 200, the printing device 200 for which an operation to generate print data is to be performed. Here, FIG. 4A illustrates a GUI screen 910A for generating print data that can be input to the printing device 200 (printer A) whose communication state with the terminal device 100 is the high-speed connection state among the printing devices 200 registered in the printing application of the terminal device 100. That is, FIG. 4A illustrates the GUI screen 910A when the tab 911 corresponding to the printing device 200 whose communication state with the terminal device 100 is the high-speed connection state is selected. FIG. 4B illustrates a GUI screen 910B for generating print data that can be input to the printing device 200 (printer B) whose communication state with the terminal device 100 is the low-speed connection state among the printing devices 200 registered in the printing application of the terminal device 100. That is, FIG. 4B illustrates the GUI screen 910B when the tab 911 corresponding to the printing device 200 whose communication state with the terminal device 100 is the low-speed connection state is selected. When the above-described restriction processing is executed in the registration of the printing device 200, since the printing device 200 whose communication state with the terminal device 100 is the low-speed connection state is not registered, the tab 911 corresponding to the printing device 200 is not displayed on the GUI screen. That is, the GUI screen 910B is a screen that can be displayed when the restriction processing is not executed in the registration.

The GUI screen 910A in FIG. 4A includes a valid print button 912. Here, the valid button refers to a button that can be operated (pressed) by the user and, when operated, receives an instruction corresponding to the button. Here, the reception of the instruction means that control processing proceeds in the terminal device 100 (printing application) so that processing corresponding to the instruction is executed. The print button 912 is an example of a button for instructing to transmit print data to the printing device 200. In the embodiment, specifically, the print button 912 is a button for instructing the terminal device 100 (printing application) to execute processing of generating print data and processing of transferring the generated print data to the printing device 200. In the embodiment, since a data generation button 914 to be described later has a function of instructing execution of processing of generating print data, the print button 912 may not include a function of instructing execution of the processing of generating print data. That is, the print button 912 may have only a function of instructing execution of processing of transferring the generated print data to the printing device 200. More specifically, the processing of transferring the generated print data to the printing device 200 refers to processing of transferring the generated print data to the printing device 200 to cause the printing device 200 to execute printing. The user selects image data to be printed on the GUI screen 910A using the input device 140 and operates (presses) the print button 912. When the user operates the valid print button 912 via the input device 140, the UI control unit 112 receives an instruction to execute processing of generating print data for the selected image data and processing of transferring the generated print data to the printing device 200. Accordingly, the data processing unit 113 generates print data for the printing device 200 corresponding to the GUI screen 910A (here, the printer A whose communication state with the terminal device 100 is the high-speed connection state). Then, the data transmission unit 114 transfers the generated print data to the printing device 200 (printer A) via the second communication path (communication path conforming to the USB standard). When the GUI screen 910A is a screen displayed on the terminal device 100a in FIG. 1, the printing device 200a corresponds to the printer A.

In contrast, the GUI screen 910B in FIG. 4B does not include the valid print button 912. In the example in FIG. 4B, the GUI screen 910B includes a disabled print button 913 (invalid print button 913). Here, the disabled button (invalid button) refers to a button that is not a valid button, and specifically refers to a button that cannot be operated (cannot be pressed) by the user or can be operated but cannot receive an instruction corresponding to the button. In the example illustrated in FIG. 4B, the user cannot operate (press) the print button 913. Alternatively, in the example illustrated in FIG. 4B, the user can operate the print button 913, but when the print button 913 is operated, an error message is displayed and an instruction is not received. Thus, the UI control unit 112 disables the print button on the GUI screen 910B for generating print data that can be input to the printing device 200 (printer B) whose communication state with the terminal device 100 is the low-speed connection state. When the GUI screen 910B is a screen displayed on the terminal device 100a in FIG. 1, the printing device 200b corresponds to the printer B. It is preferable that a display mode of the print button on the GUI screen is different between the valid print button 912 and the invalid print button 913 so that the user can recognize.

Thus, for the printing device 200 whose communication state with the terminal device 100 is the high-speed connection state, the UI control unit 112 enables the button for instructing to transmit print data to the printing device 200. For the printing device 200 whose communication state with the terminal device 100 is the low-speed connection state, the UI control unit 112 disables the button for instructing to transmit print data to the printing device 200 on the user interface screen. Therefore, it is possible to prevent the print data from being transferred via the first communication path (Ethernet communication path) to the printing device 200 whose communication state with the terminal device 100 is the low-speed connection state. The above-described processing of disabling the print button for the printing device 200 whose communication state with the terminal device 100 is the low-speed connection state is also an example of the restriction processing executed by the UI control unit 112. When this restriction processing is executed, both the printing device 200 whose communication state with the terminal device 100 is the high-speed connection state and the printing device 200 whose communication state with the terminal device 100 is the low-speed connection state can be displayed as selectable devices on the GUI screen for registration at the time of registration. These printing devices 200 can be displayed as selectable devices by, for example, designating the tab 911 on a GUI screen for generating print data. However, as described above, regarding an operation of the print button, one printing device 200 is restricted, and the other printing device 200 is not restricted.

As illustrated in FIGS. 4A and 4B, both the GUI screen corresponding to the printing device 200 whose communication state with the terminal device 100 is the high-speed connection state and the GUI screen corresponding to the printing device 200 whose communication state with the terminal device 100 is the low-speed connection state include the valid data generation button 914. The data generation button 914 is a button for instructing execution of processing of generating print data. For example, the user selects image data on the GUI screen 910B (see FIG. 4B) using the input device 140 and operates (presses) the data generation button 914. When the user operates the data generation button 914 via the input device 140, the UI control unit 112 receives an instruction to execute processing of generating print data for the selected image data. Accordingly, the data processing unit 113 generates print data for the printing device 200 corresponding to the GUI screen 910B (the printing device 200 whose communication state with the terminal device 100 is the low-speed connection state). Therefore, in the embodiment, when the printing device 200 whose communication state with the terminal device 100 is the low-speed connection state is registered, print data cannot be transmitted to the printing device 200, but print data for the printing device 200 can be generated. Therefore, for example, referring to FIG. 1, the terminal device 100b can generate print data to be printed by the printing device 200a. When the terminal device 100a can acquire the print data for the printing device 200a generated by the terminal device 100b, the terminal device 100a can transfer the print data to the printing device 200a via a high-speed communication path. Therefore, for example, the following printing method is also possible. First, a first user having abundant knowledge about printing performs editing of an image, setting of printing, and the like in the terminal device 100b, and then generates print data for the printing device 200a. Thereafter, the first user transmits the print data to the terminal device 100a used by a second user. In this case, even when the second user is a user who does not have knowledge about printing, the print data can be transferred from the terminal device 100a to the printing device 200a via a high-speed communication path, and appropriate printing can be executed.

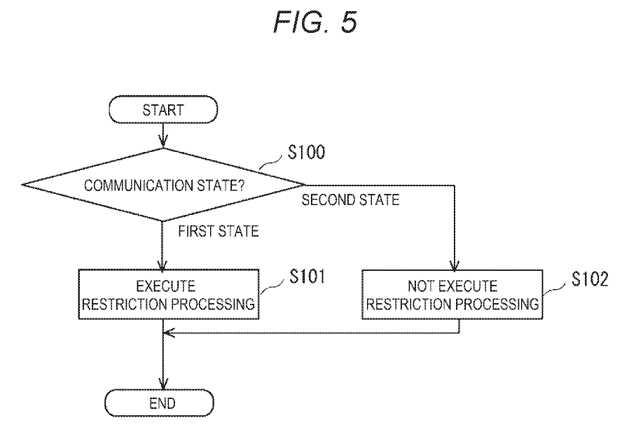

Next, an operation related to execution of the restriction processing in the embodiment will be described. FIG. 5 is a flowchart illustrating an example of a flow of processing related to execution of restriction processing. The following processing is executed for each printing device 200 capable of communicating with the terminal device 100, for example.

In step S100, the state determination unit 111 determines a communication state between the printing device 200 and the terminal device 100. That is, the state determination unit 111 determines whether the communication state between the printing device 200 and the terminal device 100 is the first state (low-speed connection state) or the second state (high-speed connection state). When the communication state is the first state, the processing proceeds to step S101, and when the communication state is the second state, the processing proceeds to step S102.

When the processing proceeds to step S101, the UI control unit 112 executes the restriction processing on the user interface screen for the printing device 200 determined in step S100. Meanwhile, when the processing proceeds to step S102, the UI control unit 112 does not execute the restriction processing on the user interface screen for the printing device 200 determined in step S100.

The embodiment has been described above. In the embodiment, when the communication state between the printing device 200 and the terminal device 100 is the second state (high-speed connection state), the UI control unit 112 receives, from the user, an instruction to transmit print data to the printing device 200. The data transmission unit 114 transmits the print data to the printing device 200 via a high-speed communication path (communication path conforming to the USB standard). However, when the communication state between the printing device 200 and the terminal device 100 is the first state (low-speed connection state), the UI control unit 112 restricts reception of an instruction to transmit print data to the printing device 200 from the user. That is, in this case, the UI control unit 112 provides the user interface screen on which the restriction processing is executed. Accordingly, it is possible to reduce occurrence of a situation in which transfer of the print data to the printing device 200 is not in time for the printing speed of the printing device 200 due to the transfer of the print data using an inappropriate communication path.

Next, some modifications of the above-described embodiment will be described. Differences from the above-described embodiment will be described, and description of overlapping configurations or processing will be omitted as appropriate.

### Modification 1

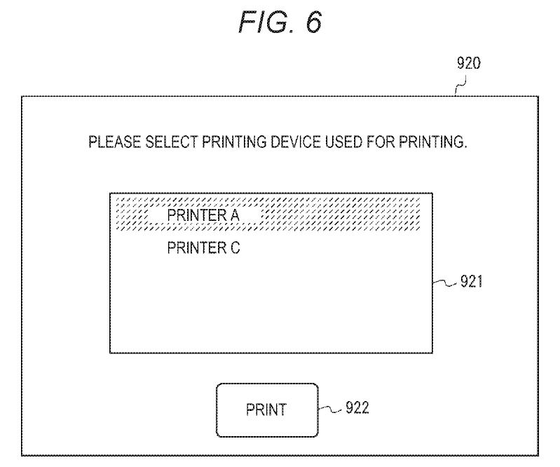

First, Modification 1 is described. The UI control unit 112 may display the printing device 200 whose communication state with the terminal device 100 is the high-speed connection state as a transmission destination of the print data in a selectable manner, and may not display the printing device 200 whose communication state with the terminal device 100 is the low-speed connection state as the transmission destination of the print data in a selectable manner on the user interface screen. FIG. 6 is a schematic diagram illustrating an example of the GUI screen displayed on the output device 150 by the UI control unit 112, and particularly illustrates a GUI screen for selecting the transmission destination of the print data. In the example illustrated in FIG. 6, the UI control unit 112 displays, on the output device 150, a GUI screen 920 in which the printing devices 200 available as the transmission destinations of the print data are listed in a list 921. The user selects one of the printing devices 200 listed in the list 921 and then presses a print button 922. The print button 922 is a button that functions similarly to the valid print button 912 illustrated in FIG. 4A, for example. Accordingly, the UI control unit 112 receives an instruction to execute processing of generating print data for executing printing in the selected printing device 200 and an instruction to execute processing of transferring the generated print data to the selected printing device 200. Here, the UI control unit 112 displays, on the output device 150, the GUI screen 920 for listing only the printing devices 200 (printer A and printer C) whose communication state with the terminal device 100 is the high-speed connection state as the selectable printing devices 200, that is, as the printing devices 200 that can be set as destinations of the print data. In other words, the UI control unit 112 displays, on the output device 150, the GUI screen 920 on which the printing device 200 (for example, printer B) whose communication state with the terminal device 100 is the low-speed connection state is not listed. Thus, the UI control unit 112 may display, on the user interface screen, the printing device 200 whose communication state with the terminal device 100 is the high-speed connection state as a selectable device, and may not display, on the user interface screen, the printing device 200 whose communication state with the terminal device 100 is the low-speed connection state as the selectable device. Such processing of the UI control unit 112 also corresponds to an example of the restriction processing. Therefore, in the modification as well, it is possible to reduce occurrence of a situation in which transfer of the print data to the printing device 200 is not in time for the printing speed of the printing device 200 due to the transfer of the print data using an inappropriate communication path.

### Modification 2

Subsequently, Modification 2 is described. In the embodiment and Modification 1 described above, the user interface screen is displayed so as not to receive any instruction to transmit print data to the printing device 200 whose communication state with the terminal device 100 is the low-speed connection state. In contrast, in the modification, the UI control unit 112 issues a predetermined warning to the user and then receives the instruction.

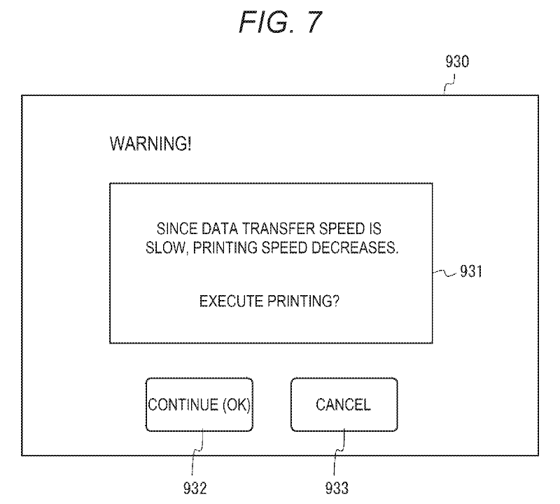

FIG. 7 is a schematic diagram illustrating an example of a GUI screen 930 displayed on the output device 150 by the UI control unit 112. Specifically, FIG. 7 illustrates an example of a warning message displayed on the output device 150 by the UI control unit 112 when an instruction to transmit print data to the printing device 200 whose communication state with the terminal device 100 is the low-speed connection state is input via the input device 140. In the modification, the UI control unit 112 arranges the valid print button 912 also on the GUI screen for generating print data that can be input to the printing device 200 whose communication state with the terminal device 100 is the low-speed connection state, similarly to FIG. 4A. When the print button is operated on the GUI screen for generating print data that can be input to the printing device 200 whose communication state with the terminal device 100 is the low-speed connection state, the UI control unit 112 displays a warning message as illustrated in FIG. 7 on the output device 150. Specifically, for example, as illustrated in FIG. 7, the UI control unit 112 displays the GUI screen 930 including a warning message 931 for describing a disadvantage that may occur due to transfer of the print data via the low-speed communication path, a continue button 932 for instructing execution of transfer processing, and a cancel button 933 for canceling the execution of the transfer processing.

In contrast, when the print button is operated on the GUI screen for generating print data that can be input to the printing device 200 whose communication state with the terminal device 100 is the high-speed connection state, the UI control unit 112 receives an instruction corresponding to the print button without outputting the above-described warning screen.

Thus, for the printing device 200 whose communication state with the terminal device 100 is the high-speed connection state, when the button for instructing to transmit print data to the printing device 200 is pressed, the UI control unit 112 receives an instruction to transmit print data to the printing device 200 without outputting a warning. In contrast, for the printing device 200 whose communication state with the terminal device 100 is the low-speed connection state, the UI control unit 112 displays a predetermined warning when the button for instructing to transmit print data to the printing device 200 is pressed. After the warning is displayed, when the user instructs to transmit the print data by operating the continue button 932 or the like, the UI control unit 112 receives an instruction to transmit the print data to the printing device 200. Such an output of the warning by the UI control unit 112 also corresponds to an example of the restriction processing. Therefore, in the modification as well, it is possible to reduce occurrence of a situation in which transfer of the print data to the printing device 200 is not in time for the printing speed of the printing device 200 due to the transfer of the print data using an inappropriate communication path.

### Embodiment 2

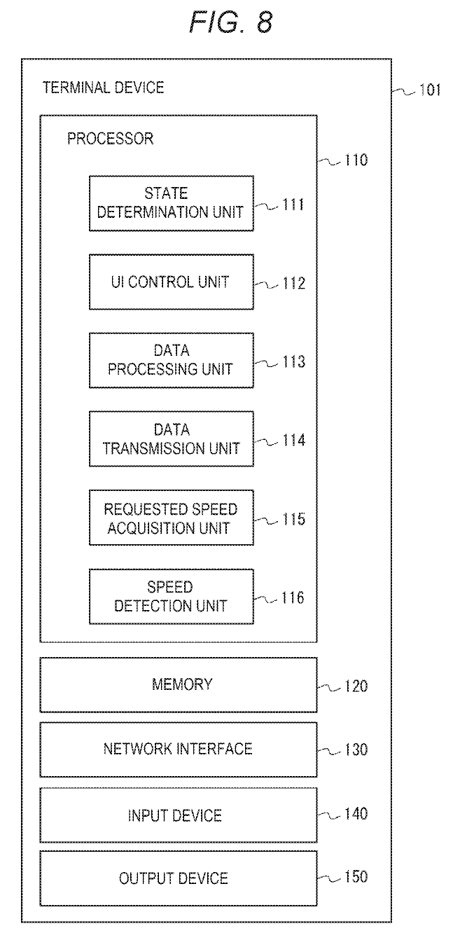

Embodiment 2 will be described. Differences from Embodiment 1 described above will be described, and description of overlapping configurations or processing will be omitted as appropriate. Each of the modifications described above is also applicable to the embodiment. Embodiment 2 is different from the information processing system 1 according to Embodiment 1 in that the terminal device 100 is replaced with a terminal device 101. FIG. 8 is a block diagram illustrating an example of a configuration of the terminal device 101 according to Embodiment 2. As illustrated in FIG. 8, the terminal device 101 is different from the terminal device 100 in that the terminal device 101 further includes a requested speed acquisition unit 115 and a speed detection unit 116. Functions of the requested speed acquisition unit 115 and the speed detection unit 116 are also achieved by, for example, the processor 110 reading and executing a program from the memory 120. The requested speed acquisition unit 115 and the speed detection unit 116 may be implemented as a program of the printing application.

The requested speed acquisition unit 115 inquires of each printing device 200 communicably connected to the terminal device 101 about a requested speed. Here, the requested speed is a data transfer speed requested by the printing device 200 to prevent transfer of print data from being delayed in printing processing in the printing device 200. That is, the requested speed can be said to be a lower limit value of the data transfer speed at which the transfer of the print data can be prevented from being delayed in the printing processing in the printing device 200. The requested speed acquisition unit 115 transmits, for example, an inquiry signal for inquiring the requested speed to each printing device 200. In response to this, the printing device 200 that receives the inquiry signal transmits information indicating a predetermined requested speed to the terminal device 101 as a response signal. Accordingly, the requested speed acquisition unit 115 acquires the requested speed for each printing device 200.

In Embodiment 1 described above, for example, even when a transfer destination of the print data is the printing device 200 that does not achieve high-speed printing (that is, the printing device 200 having a low requested speed), the transfer of the print data is restricted by the UI control unit 112. However, it is preferable that print data can be transferred to such a printing device 200 regardless of the communication path. Therefore, in the embodiment, the UI control unit 112 uses, as a condition for performing control for restricting reception of an instruction to transmit print data to the printing device 200 from the user, not only that the communication state is the low-speed connection state, but also that the requested speed is equal to or greater than a predetermined threshold. That is, the UI control unit 112 restricts reception of an instruction to transmit print data from the user to the printing device 200, which is the printing device 200 whose communication state with the terminal device 101 is the low-speed connection state and whose requested speed is equal to or greater than the predetermined threshold. Accordingly, it is possible to avoid the restriction from being imposed when the restriction is not necessary.

The speed detection unit 116 measures a data transfer speed of the first communication path (communication path conforming to the Ethernet standard). For example, the speed detection unit 116 measures the data transfer speed by transmitting and receiving data to and from the printing device 200 via the first communication path.

In the above-described embodiment, when the printing device 200 can communicate with the terminal device 100 only via the first communication path (communication path conforming to the Ethernet standard), the UI control unit 112 executes any of the above-described restriction processing on the user interface screen for the printing device 200. However, although a widely used Ethernet cable is a 1 Gb Ethernet cable, a network such as a local area network may be constructed using a higher-speed Ethernet cable. In such a case, transmission of the print data is restricted even though high-speed transfer of the print data via the first communication path is possible. Therefore, in the embodiment, the UI control unit 112 uses, as a condition for performing control for restricting reception of an instruction to transmit print data to the printing device 200 from the user, not only that communication with the printing device 200 can be performed only via the first communication path, but also that the measured data transfer speed of the first communication path is less than a requested speed. That is, the UI control unit 112 restricts the reception of an instruction from the user to transmit print data to the printing device 200 that can communicate only via the first communication path, the first communication path having a data transfer speed less than the requested speed. Accordingly, it is possible to avoid the restriction from being imposed when the restriction is not necessary.

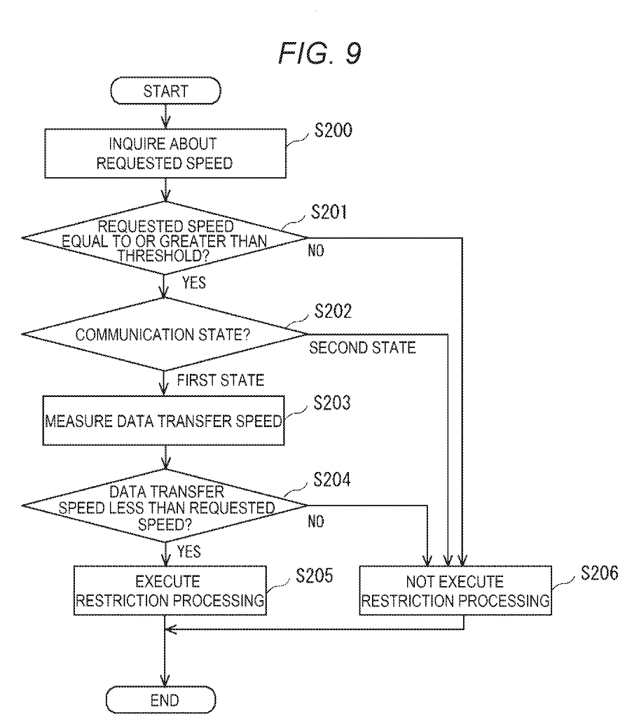

Next, an operation related to execution of the restriction processing in the embodiment will be described. FIG. 9 is a flowchart illustrating an example of a flow of processing related to the execution of the restriction processing according to Embodiment 2. The following processing is executed for each printing device 200 capable of communicating with the terminal device 101, for example.

In step S200, the requested speed acquisition unit 115 inquires of the printing device 200 about a requested speed, thereby acquiring the requested speed.

Next, in step S201, the state determination unit 111 determines whether the acquired requested speed is equal to or greater than a predetermined threshold. When the requested speed is equal to or greater than the predetermined threshold, the processing proceeds to step S202, and when the requested speed is less than the predetermined threshold, the processing proceeds to step S206.

In step S202, the state determination unit 111 determines the communication state between the printing device 200 and the terminal device 101. That is, the state determination unit 111 determines whether the communication state between the printing device 200 and the terminal device 101010 is a first state in which communication only via the first communication path (Ethernet) is possible or a second state in which communication via the second communication path (USB) is possible. When the communication state is the first state, the processing proceeds to step S203, and when the communication state is the second state, the processing proceeds to step S206.

In step S203, the speed detection unit 116 measures a data transfer speed of the first communication path (communication path conforming to the Ethernet standard). Thereafter, the processing proceeds to step S204.

In step S204, the state determination unit 111 determines whether the measured data transfer speed is less than the requested speed. When the measured data transfer speed is less than the requested speed, the processing proceeds to step S205. In contrast, when the measured data transfer speed is equal to or higher than the requested speed, the processing proceeds to step S206.

When the processing proceeds to step S205, the UI control unit 112 executes the restriction processing on the user interface screen for the printing device 200 determined in the above-described step. In contrast, when the processing proceeds to step S206, the UI control unit 112 does not execute the restriction processing on the user interface screen for the printing device 200.

Although Embodiment 2 is described above, the terminal device 101 may not necessarily include both the requested speed acquisition unit 115 and the speed detection unit 116. That is, the terminal device 101 may include any one of the requested speed acquisition unit 115 and the speed detection unit 116. When the terminal device 101 does not include the requested speed acquisition unit 115, it may be assumed that a requested speed of the printing device 200 is a predetermined speed, and determination processing of whether to execute the restriction processing may be executed. That is, in step S204 described above, the state determination unit 111 may use a predetermined speed instead of the requested speed acquired by the requested speed acquisition unit 115.

In Embodiment 1, Embodiment 2, and the modifications, as a specific example of the first communication path, a communication path of wired communication conforming to the Ethernet standard is described, but the first communication path is not limited thereto. For example, the first communication path may be a wireless communication path conforming to a Wi-Fi (registered trademark) standard.

In the present disclosure, the program includes a command group (or software codes) for causing a computer to perform one or more functions described in the embodiment when the program is read by the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD) or devices based on other memory technologies, a CD-ROM, a digital versatile disc (DVD), a Blu-ray (registered trademark) disc or other optical disc storages, a magnetic cassette, a magnetic tape, a magnetic disk storage or other magnetic storage devices. The program may be transmitted via a transitory computer-readable medium or a communication medium. Examples of the transitory computer-readable medium or the communication medium include, but not limited to, a propagation signal of an electric, optical, acoustic, or another form.

A part or the entire embodiment or the modifications above can also be described as indicated by the following appendixes but is not limited to the following.

### Appendix 1

A terminal device that communicates with a printing device, the terminal device including:

a state determination unit configured to determine whether a communication state between the printing device and the terminal device is a first state in which communication is possible via a first communication path and is not possible via a second communication path or a second state in which communication is possible via the second communication path; and

a user interface control unit configured to control a user interface, in which

the first communication path and the second communication path are communication paths in which communication is performed according to different standards, and

the user interface control unit

restricts reception of an instruction for transmitting print data to the printing device from a user when the communication state is the first state, and

receives the instruction for transmitting the print data to the printing device from the user when the communication state is the second state.

### Appendix 2

The terminal device according to Appendix 1, in which

the user interface control unit

does not display the printing device on a user interface screen as a selectable device when the communication state is the first state, and

displays the printing device on the user interface screen as the selectable device when the communication state is the second state.

### Appendix 3

The terminal device according to Appendix 1, in which

the user interface control unit

disables a button for instructing to transmit the print data to the printing device on a user interface screen when the communication state is the first state, and

enables the button when the communication state is the second state.

### Appendix 4

The terminal device according to Appendix 1, in which

the user interface control unit

displays, when the communication state is the first state, a predetermined warning when a button for instructing to transmit the print data to the printing device is pressed, receives the instruction to transmit the print data to the printing device when the transmission of the print data is instructed from the user after the warning is displayed, and

receives, when the communication state is the second state, when the button is pressed, the instruction to transmit the print data to the printing device without displaying the warning.

### Appendix 5

The terminal device according to any one of Appendixes 1 to 4, further including:

a requested speed acquisition unit configured to inquire of the printing device about a requested speed, which is a data transfer speed requested by the printing device, in which

the user interface control unit uses, as a condition for performing control for restricting reception of the instruction to transmit the print data to the printing device from the user, not only that the communication state is the first state, but also that the requested speed is equal to or greater than a predetermined threshold.

### Appendix 6

The terminal device according to any one of Appendixes 1 to 5, further including:

a speed detection unit configured to measure a data transfer speed of the first communication path, in which

the user interface control unit uses, as the condition for performing the control for restricting the reception of the instruction to transmit the print data to the printing device from the user, not only that the communication state is the first state, but also that the measured data transfer speed of the first communication path is less than the requested speed, and

the requested speed is a data transfer speed requested by the printing device.

### Appendix 7

The terminal device according to any one of Appendixes 1 to 6, in which

a data transfer speed of the second communication path is higher than the data transfer speed of the first communication path.

### Appendix 8

The terminal device according to any one of Appendixes 1 to 7, in which

the first communication path is a communication path in which communication is performed according to an Ethernet standard.

### Appendix 9

The terminal device according to any one of Appendixes 1 to 8, in which

the second communication path is a communication path in which communication is performed according to a universal serial bus (USB) 3.0 standard or a successor standard of the USB 3.0 standard.

### Appendix 10

The terminal device according to any one of Appendixes 1 to 9, in which

the terminal device is a device that communicates with the printing device that transmits operation information to a cloud server using the first communication path.

### Appendix 11

An information processing system including:

a printing device configured to transmit operation information to a cloud server using a first communication path; and

a terminal device configured to communicate with the printing device, in which

the terminal device includes

a state determination unit configured to determine whether a communication state between the printing device and the terminal device is a first state in which communication is possible via the first communication path and is not possible via a second communication path or a second state in which communication is possible via the second communication path, and

a user interface control unit configured to control a user interface, in which

the first communication path and the second communication path are communication paths in which communication is performed according to different standards, and

the user interface control unit

restricts reception of an instruction for transmitting print data to the printing device from a user when the communication state is the first state, and

receives the instruction for transmitting the print data to the printing device from the user when the communication state is the second state.

### Appendix 12

A non-transitory computer-readable storage medium storing a program, the program causing a computer of a terminal device that communicates with a printing device to execute operations including:

a state determination step of determining whether a communication state between the printing device and the terminal device is a first state in which communication is possible via a first communication path and is not possible via a second communication path or a second state in which communication is possible via the second communication path; and

a user interface control step of controlling a user interface, in which

the first communication path and the second communication path are communication paths in which communication is performed according to different standards, and

in the user interface control step,

reception of an instruction for transmitting print data to the printing device from a user is restricted when the communication state is the first state, and

the instruction for transmitting the print data to the printing device is received from the user when the communication state is the second state.

What is claimed is:

1. A terminal device that communicates with a printing device, the terminal device comprising:
a state determination unit configured to determine whether a communication state between the printing device and the terminal device is a first state in which communication is possible via a first communication path and is not possible via a second communication path or a second state in which communication is possible via the second communication path; and
a user interface control unit configured to control a user interface, wherein
the first communication path and the second communication path are communication paths in which communication is performed according to different standards, and
the user interface control unit
restricts reception of an instruction for transmitting print data to the printing device from a user when the communication state is the first state, and
receives the instruction for transmitting the print data to the printing device from the user when the communication state is the second state.

2. The terminal device according to claim 1, wherein
the user interface control unit
does not display the printing device on a user interface screen as a selectable device when the communication state is the first state, and
displays the printing device on the user interface screen as the selectable device when the communication state is the second state.

3. The terminal device according to claim 1, wherein
the user interface control unit
disables a button for instructing to transmit the print data to the printing device on a user interface screen when the communication state is the first state, and
enables the button when the communication state is the second state.

4. The terminal device according to claim 1, wherein
the user interface control unit
displays, when the communication state is the first state, a predetermined warning when a button for instructing to transmit the print data to the printing device is pressed, receives the instruction to transmit the print data to the printing device when the transmission of the print data is instructed from the user after the warning is displayed, and
receives, when the communication state is the second state, when the button is pressed, the instruction to transmit the print data to the printing device without displaying the warning.

5. The terminal device according to claim 1, further comprising:
a requested speed acquisition unit configured to inquire of the printing device about a requested speed, which is a data transfer speed requested by the printing device, wherein
the user interface control unit uses, as a condition for performing control for restricting reception of the instruction to transmit the print data to the printing device from the user, not only that the communication state is the first state, but also that the requested speed is equal to or greater than a predetermined threshold.

6. The terminal device according to claim 1, further comprising:
a speed detection unit configured to measure a data transfer speed of the first communication path, wherein
the user interface control unit uses, as a condition for performing control for restricting reception of the instruction to transmit the print data to the printing device from the user, not only that the communication state is the first state, but also that the measured data transfer speed of the first communication path is less than a requested speed, and
the requested speed is a data transfer speed requested by the printing device.

7. The terminal device according to claim 1, wherein
a data transfer speed of the second communication path is higher than a data transfer speed of the first communication path.

8. The terminal device according to claim 1, wherein
the first communication path is a communication path in which communication is performed according to an Ethernet standard.

9. The terminal device according to claim 1, wherein
the second communication path is a communication path in which communication is performed according to a universal serial bus (USB) 3.0 standard or a successor standard of the USB 3.0 standard.

10. The terminal device according to claim 1, wherein
the terminal device is a device that communicates with the printing device that transmits operation information to a cloud server using the first communication path.

11. An information processing system comprising:
a printing device configured to transmit operation information to a cloud server using a first communication path; and
a terminal device configured to communicate with the printing device, wherein
the terminal device includes
a state determination unit configured to determine whether a communication state between the printing device and the terminal device is a first state in which communication is possible via the first communication path and is not possible via a second communication path or a second state in which communication is possible via the second communication path, and
a user interface control unit configured to control a user interface, in which
the first communication path and the second communication path are communication paths in which communication is performed according to different standards, and
the user interface control unit
restricts reception of an instruction for transmitting print data to the printing device from a user when the communication state is the first state, and
receives the instruction for transmitting the print data to the printing device from the user when the communication state is the second state.

12. A non-transitory computer-readable storage medium storing a program, the program causing a computer of a terminal device that communicates with a printing device to execute operations comprising:
a state determination step of determining whether a communication state between the printing device and the terminal device is a first state in which communication is possible via a first communication path and is not possible via a second communication path or a second state in which communication is possible via the second communication path; and
a user interface control step of controlling a user interface, wherein
the first communication path and the second communication path are communication paths in which communication is performed according to different standards, and
in the user interface control step,
reception of an instruction for transmitting print data to the printing device from a user is restricted when the communication state is the first state, and
the instruction for transmitting the print data to the printing device is received from the user when the communication state is the second state.
